(19) United States
(12) Patent Application Publication
(10) Pub. No.: US 2026/0341229 A1
(43) Pub. Date: Oct. 29, 2026

(54) DISPLAY DEVICE

(71) Applicant: LG DISPLAY CO., LTD., SEOUL (KR)

(72) Inventors: YoungKyu Shin, Paju-si (KR); Hyunjik Bae, Paju-si (KR)

(21) Appl. No.: 19/655,940

(22) Filed: Apr. 23, 2026

(30) Foreign Application Priority Data
Apr. 28, 2025 (KR) 10-2025-0055083

(51) Int. Cl. G09G 3/3266; G09G 3/32; G09G 3/3233

(52) U.S. Cl. CPC G09G 3/3266; G09G 3/32; G09G 3/3233; G09G 2300/0426; G09G 2300/0842; G09G 2310/0297; G09G 2310/08; G09G 2330/026; G09G 2330/027

(57) ABSTRACT

A display device including a display panel including 2n subpixel lines (n is a natural number greater than or equal to 2) disposed in a display area, and a gate driving circuit configured to supply a gate signal to each of the 2n subpixel lines. The 2n subpixel lines can be grouped into n driving groups, with each driving group including two subpixel lines, and identical gate signals can be supplied to the two subpixel lines included in each driving group of the n driving groups.

### CROSS REFERENCE TO RELATED APPLICATION

Pursuant to 35 U.S.C. § 119(a), this application claims the benefit of an earlier filing date and right of priority to Korean Patent Application No. 10-2025-0055083, filed on Apr. 28, 2025 in the Korean Intellectual Property Office, the entire content of which is hereby incorporated by reference for all purposes as if fully set forth herein.

### TECHNICAL FIELD

The present disclosure relates to electronic devices with displays, and more specifically, to display devices.

### BACKGROUND

Recently, with increasing demands for high resolution and diverse application technologies, there are rising the necessity of high-speed driving of display devices. However, challenges can arise in providing display devices capable of performing high-speed driving due to various limitations.

### SUMMARY

According to one or more example implementations of the present disclosure, a display device can be provided that includes a display panel including 2n subpixel lines (n is a natural number greater than or equal to 2) disposed in a display area, and a gate driving circuit configured to supply a gate signal to each of the 2n subpixel lines. In one or more aspects, the 2n subpixel lines may be grouped into n driving groups, with each driving group including two subpixel lines, and identical gate signals may be supplied to the two subpixel lines included in each driving group of the n driving groups.

According to one or more example implementations of the present disclosure, a display device can be provided that includes a display panel including a plurality of subpixels, each subpixel of the plurality of subpixels including: a first light emitting element, a second light emitting element, and a sub pixel circuit configured to drive one of the first light emitting element and the second light emitting element or alternately drive the first light emitting element and the second light emitting element. In one or more aspects, the subpixel circuit may include a common circuit including a common transistor configured to be turned on during a driving period of the first light emitting element and a driving period of the second light emitting element, a first individual circuit including a first individual transistor configured to be turned on during the driving period of the first light emitting element, and a second individual circuit including a second individual transistor configured to be turned on during the driving period of the second light emitting element.

### BRIEF DESCRIPTION OF THE DRAWINGS

The accompanying drawings, which are included to provide a further understanding of the disclosure and are incorporated in and constitute a part of the disclosure, illustrate aspects of the disclosure and together with the description serve to explain principles of the disclosure. In the drawings:

FIG. 1 illustrates an example display device according to aspects of the present disclosure;

FIG. 2 illustrates an example display panel according to aspects of the present disclosure;

FIGS. 3 to 6 illustrate an example first high-speed driving of the display device according to aspects of the present disclosure;

FIGS. 7 to 10 illustrate an example second high-speed driving of the display device according to aspects of the present disclosure;

FIGS. 11 and 12 illustrate examples multi-view displays of the display device according to aspects of the present disclosure;

FIG. 13 is an example equivalent circuit for a subpixel of the display device according to aspects of the present disclosure;

FIG. 14 illustrates an example cross-sectional view of the display panel according to aspects of the present disclosure;

FIG. 15 illustrates an example gate driving circuit of the display device according to aspects of the present disclosure; and

FIGS. 16 and 17 are example driving timing diagrams for causing a first light emitting element and a second light emitting element in a subpixel to emit light in the display device according to aspects of the present disclosure.

### DETAILED DESCRIPTION

Implementations of the present disclosure can provide a display device that is capable of performing high-speed driving.

Implementations of the present disclosure can also provide a display device that is capable of presenting various multi-view displays.

According to one or more aspects of the present disclosure, a display device may be provided that is capable of performing high-speed driving based on group driving of subpixel lines.

According to one or more aspects of the present disclosure, a display device may be provided that is capable of performing high-speed driving based on high-scanning rate driving.

According to one or more aspects of the present disclosure, a display device may be provided that is capable of normally implementing various multi-view displays based on high-speed driving.

According to one or more aspects of the present disclosure, a display device may be provided that is environmentally friendly based on a low power driving capable structure in which high-speed driving can be performed through group driving without increasing an operating speed of a driving circuit.

Reference will now be made in detail to example implementations of the present disclosure, examples of which may be illustrated in the accompanying drawings. In the following description, the structures, implementations, implementations, methods and operations described herein are not limited to the specific example or examples set forth herein and may be changed as is known in the art, unless otherwise specified. Like reference numerals designate like elements throughout, unless otherwise specified. Names of the respective elements used in the following explanations are selected only for convenience of writing the specification and may thus be different from those used in actual products. Advantages and features of the present disclosure, and implementation methods thereof will be clarified through following example implementations described with reference to the accompanying drawings. The present disclosure may, however, be embodied in different forms and should not be construed as limited to the example implementations set forth herein. Rather, these example implementations are provided so that this disclosure may be sufficiently thorough and complete to assist those skilled in the art to fully understand the scope of the present disclosure. Further, the protected scope of the present disclosure is defined by claims and their equivalents. In the following description, where the detailed description of the relevant known function or configuration may unnecessarily obscure aspects of the present disclosure, a detailed description of such known function or configuration may be omitted. The shapes, sizes, ratios, angles, numbers, and the like, which are illustrated in the drawings to describe various example implementations of the present disclosure, are merely given by way of example. Therefore, the present disclosure is not limited to the illustrations in the drawings. Where the terms “comprise,” “have,” “include,” “contain,” “constitute,” “make up of,” “formed of,” and the like are used, one or more other elements may be added unless the term, such as “only,” is used. An element described in the singular form is intended to include a plurality of elements, and vice versa, unless the context clearly indicates otherwise.

Although the terms “first,” “second,” “A”, “B”, “(a)”, or “(b)”, and the like may be used herein to describe various elements, these elements should not be interpreted to be limited by these terms as they are not used to define a particular order or precedence. These terms are used only to distinguish one element from another; thus, related elements should not be interpreted to be limited by these terms as they are not used to define a particular order or precedence. Further, the expression of a first element, a second elements “and/or” a third element should be understood as one of the first, second and third elements or as any or all combinations of the first, second and third elements. By way of example, A, B and/or C can refer to only A, only B, or only C; any or some combination of A, B, and C; or all of A, B, and C. In the following description, various example aspects of the present disclosure are described in detail with reference to the accompanying drawings. With respect to reference numerals to elements of each of the drawings, the same elements may be illustrated in other drawings, and like reference numerals may refer to like elements unless stated otherwise. The same or similar elements may be denoted by the same reference numerals even though they are depicted in different drawings. In addition, for convenience of description, a scale, dimension, size, and thickness of each of the elements illustrated in the accompanying drawings may be different from an actual scale, dimension, size, and thickness, and thus, aspects of the present disclosure are not limited to a scale, dimension, size, and thickness illustrated in the drawings.

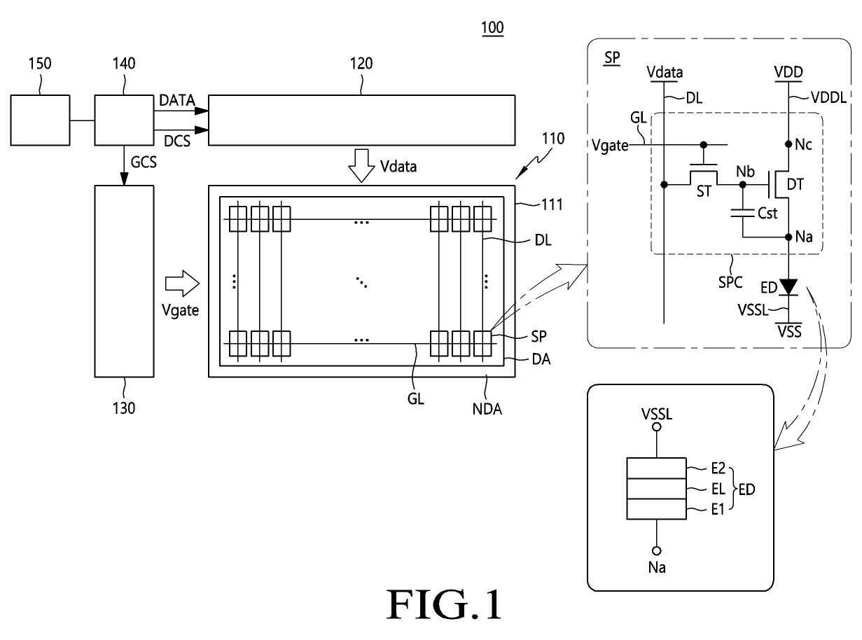

FIG. 1 illustrates an example display device 100 according to aspects of the present disclosure.

Referring to FIG. 1, in one or more example implementations, the display device 100 may include a display panel 110 and at least one display driving circuit for driving the display panel 110. For example, the at least one display driving circuit may include a data driving circuit 120, a gate driving circuit 130, a controller 140, and one or more other circuits.

The display panel 110 may include a display area DA where an image can be displayed, and a non-display area NDA around an outer edge of the display area DA. The display area DA may include a plurality of subpixels SP for presenting images, and a plurality of data lines DL and a plurality of gate lines GL for driving the plurality of subpixels SP. The non-display area NDA may include a pad area to which at least one driving circuit is connected.

In one or more aspects, the display device 100 may be a non-self-emissive display device (e.g., a liquid crystal display device, or the like) in which light for presenting an image is not emitted from the display panel 110 itself, or a self-emissive display device in which light can be emitted from the display panel 110 itself.

In examples where the display device 100 is a self-emissive display device, the display device 100 may be an organic light emitting display device in which light emitting elements are implemented using organic light emitting diodes (OLED), an inorganic light emitting display device in which light emitting elements are implemented using inorganic material-based light emitting diodes (LED), a quantum dot display device in which light emitting elements are implemented using quantum dots (QD), which are self-emissive semiconductor crystals, a micro light emitting diode (LED) display device, or a mini light emitting diode (LED) display device.

The display panel 110 may include a plurality of data lines DL for delivering data signals Vdata to a plurality of subpixels SP and a plurality of gate lines GL for delivering gate signals Vgate to the plurality of subpixels SP.

Herein, a data signal Vdata may also be referred to a data voltage, an image data signal, an image data voltage, an image signal, an image voltage, or the like, and a gate signal Vgate may also be referred to as a gate voltage, or the like. For example, a gate signal Vgate may include a scan signal, an emission control signal, and the like. The scan signal, the emission control signal, and the like may be gate signals Vgate with different functions.

The data driving circuit 120 can receive image data DATA in a digital form from the controller 140, convert the received image data DATA into data signals in an analog form, and output the resulting data signals to a plurality of data lines DL according to one or more data driving control signals.

The gate driving circuit 130 can generate one or more gate signals Vgate including a period with a turn-on level voltage and a period with a turn-off level voltage based on several types of gate driving control signals GCS, and output the generated gate signals to a plurality of gate lines GL. For example, the turn-on level voltage may be a high level voltage and the turn-off level voltage may be a low level voltage. In another example, the turn-on level voltage may be a low level voltage and the turn-off level voltage may be a high level voltage.

For example, the gate driving circuit 130 may be implemented in at least one integrated circuit and be connected to the substrate 111. In another example, the gate driving circuit 130 may be implemented in a gate-in-panel (GIP) structure and be disposed on the substrate 111. The gate driving circuit 130 with the GIP structure may be disposed in the non-display area NDA or display area DA of the display panel 110.

The controller 140 can receive image data from a host system 150 and supply image data DATA readable by the data driving circuit 120 based on the received image data to the data driving circuit 120. The controller 140 can control operation times of the data driving circuit 120 and the gate driving circuit 130. To control the operation times of the data driving circuit 120 and the gate driving circuit 130, the controller 140 can supply at least one data control signal DCS to the data driving circuit 120, and supply at least one gate control signal GCS to the gate driving circuit 130.

In one or more aspects, the display device 100 may be, or be applied to, a mobile device, a video phone, a smart watch, a watch phone, a wearable device, a foldable device, a rollable device, a bendable device, a flexible device, a curved device, a sliding device, a variable device, an electronic notebook, an e-book, a portable multimedia player (PMP), a personal digital assistant (PDA), an MP3 player, a mobile medical device, a desktop PC, a laptop PC, a netbook computer, a workstation, a navigation device, a car navigation device, a vehicle display device, a vehicle apparatus, a theater apparatus, a theater display apparatus, a television (TV), a wallpaper device, a signage device, a game device, a notebook computer, a monitor, a camera, a camcorder, and a home appliance, and the like. However, aspects of the present disclosure are not limited thereto.

Each of the plurality of subpixels SP may include a light emitting element ED and a subpixel circuit SPC for driving the light emitting element ED by supplying a driving current to the light emitting element ED at a predetermined time.

The subpixel circuit SPC may include a driving transistor DT for driving the light emitting element ED, a scan transistor ST configured to be turned on and off according to a gate signal Vgate, and a storage capacitor Cst for maintaining a voltage at an approximate constant level during a predefined period of time. For example, the gate signal Vgate applied to the gate node of the scan transistor ST may also be referred to as a scan signal.

The light emitting element ED may include a first electrode E1, an emission layer EL, and a second electrode E2. For example, the first electrode E1 may be a pixel electrode, and the second electrode E2 may be a common electrode. In another example, the first electrode E1 may be a common electrode, and the second electrode E2 may be a pixel electrode. In another example, the first electrode E1 may be an anode electrode, and the second electrode E2 may be a cathode electrode. In another example, the first electrode E1 may be a cathode electrode, and the second electrode E2 may be an anode electrode. The emission layer EL may include at least one organic material layer.

The first electrode E1 may be electrically connected, directly or indirectly, to a first node Na of the corresponding driving transistor DT of each subpixel SP. The second electrode E2 may be electrically connected to a first common voltage line VSSL to which a first common voltage VSS, a type of common voltage, is applied. The first common voltage VSS may also be referred to as a low driving voltage, a low power supply voltage, or a low voltage.

The driving transistor DT may be connected between the second common voltage line VDDL and the light emitting element ED. The driving transistor DT may include a first node Na, a second node Nb, and a third node Nc. The first node Na may be electrically connected to the light emitting element ED and be a source node or a drain node. A data signal Vdata may be applied to the second node Nb and be a gate node. The third node Nc may be the drain node or the source node to which a second common voltage VDD delivered through a second common voltage line VDDL is applied. The second common voltage VDD may also be referred to as a high driving voltage, a high power supply voltage, or a high voltage.

The scan transistor ST may be connected between a data line DL and the second node Nb of the driving transistor DT. The scan transistor ST may be turned on and off by a gate signal Vgate, which is a type of gate signal applied through a scan line SCL, which is a type of gate line GL, and thereby control an electrical connection between the second node Nb of the driving transistor DT and the data line DL.

Each of the driving transistor DT and the scan transistor ST may be an n-type or p-type transistor. The subpixel circuit SPC may further include one or more transistors and/or one or more capacitors according to design requirements.

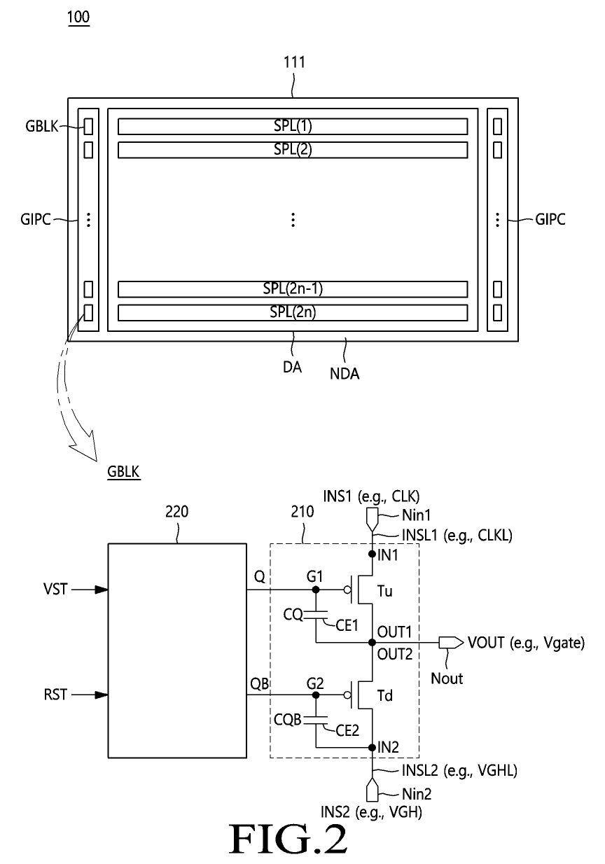

FIG. 2 illustrates an example configuration of the display panel 110 according to aspects of the present disclosure.

In one or more aspects, the display area DA of the display panel 110 may include n subpixel lines (SPL(1) to SPL(n)). Here, n may be a natural number greater than or equal to 2. Each of the n subpixel lines (SPL(1) to SPL(n)) may include a plurality of subpixels SP disposed in a row or column direction.

At least one gate line GL may be arranged to correspond to each of the n subpixel lines (SPL(1) to SPL(n)).

In one or more aspects, the gate driving circuit 130 may be implemented as a gate-in-panel (GIP) circuit GIPC embedded in the display panel 110 in the GIP structure. Herein, the gate driving circuit 130 implemented in the GIP structure may also be referred to as the gate-in-panel circuit GIPC.

For example, as illustrated in FIG. 2, the gate-in-panel circuit GIPC may be disposed in the non-display area NDA, and be disposed around at least one of two opposing sides or edges of the display area DA. In another example, all or a part of the gate-in-panel circuit GIPC may be disposed in the display area DA.

The gate-in-panel circuit GIPC may include a plurality of gate driving blocks GBLK corresponding to a plurality of stages. Each of the plurality of gate driving blocks GBLK may include an output buffer circuit 210 and a control circuit 220.

The output buffer circuit 210 can output an output signal VOUT generated based on two input signals (INS1 and INS2) as a gate signal Vgate to a corresponding gate line GL and include a pull-up transistor Tu and a pull-down transistor Td.

The control circuit 220 can control voltages of a first control node Q and a second control node QB of the output buffer circuit 210. The first control node Q may correspond to the gate node of the pull-up transistor Tu, and the second control node QB may correspond to the gate node of the pull-down transistor Td.

The pull-up transistor Tu and the pull-down transistor Td may be connected between a first input node Nin1 and a second input node Nin2. The first input node Nin1 may be a node to which the first input signal INS1 is input, and be electrically connected to a first input signal line INSL1. The second input node Nin2 may be a node to which the second input signal INS2 is input, and be electrically connected to a second input signal line INSL2. The output node Nout may be a node from which the output signal VOUT is output as the gate signal Vgate and be electrically connected to the gate line GL.

The pull-up transistor Tu may be connected between the first input node Nin1 and the output node Nout, and include a first input electrode IN1, a first output electrode OUT1, and a first gate electrode G1. The first input electrode IN1 may be electrically connected to the first input node Nin1, the first output electrode OUT1 may be electrically connected to the output node Nout, and the first gate electrode G1 may be electrically connected to the first control node Q.

The pull-up transistor Tu can control a connection between the first input node Nin1 and the output node Nout according to a voltage of the first control node Q.

The pull-down transistor Td may be connected between the second input node Nin2 and the output node Nout, and include a second input electrode IN2, a second output electrode OUT2, and a second gate electrode G2. The second input electrode IN2 may be electrically connected to the second input node Nin2, the second output electrode OUT2 may be electrically connected to the output node Nout, and the second gate electrode G2 may be electrically connected to the second control node QB.

The pull-down transistor Td can control a connection between the second input node Nin2 and the output node Nout according to a voltage of the second control node QB.

The control circuit 220 may include a plurality of transistors and can receive a start signal VST and a reset signal RST.

The voltage of the first control node Q and the voltage of the second control node QB may have different voltage levels. When the voltage of the first control node Q is a high-level voltage, the voltage of the second control node QB may be a low-level voltage. When the voltage of the first control node Q is the low-level voltage, the voltage of the second control node QB may be the high-level voltage.

The turn-on and turn-off states of the pull-up transistor Tu may be opposite to the turn-on and turn-off states of the pull-down transistor Td. For example, when the pull-up transistor Tu is in the turn-on state, the pull-down transistor Td may be in the turn-off state. When the pull-up transistor Tu is in the turn-off state, the pull-down transistor Td may be in the turn-on state.

The first input signal INS1 and the second input signal INS2 may be different signals from each other. For example, the first input signal INS1 may be a clock signal CLK, and the second input signal INS2 may be a gate high-level voltage VGH. In this example, each of the pull-up transistor Tu and the pull-down transistor Td may be a p-type transistor. In another example, the first input signal INS1 may be a clock signal CLK, and the second input signal INS2 may be a gate low-level voltage VGL. In this example, each of the pull-up transistor Tu and the pull-down transistor Td may be an n-type transistor.

The output buffer circuit 210 may further include at least one of a first capacitor CQ or a second capacitor CQB. The first capacitor CQ may be disposed (formed, or connected) between the first gate electrode G1 of the pull-up transistor Tu and the first output electrode OUT1. The second capacitor CQB may be disposed (formed, or connected) between the second gate electrode G2 of the pull-down transistor Td and the second input electrode IN2.

Recently, with increasing demands for high resolution and/or diverse application technologies, there are rising the necessity of high-speed driving of display devices. To satisfy these needs, in one or more example implementations, the display device 100 may be configured with a high-speed driving system for displaying images at a high speed. Hereinafter, discussions are provided for high-speed driving of the display device 100 and a multi-view display technology based on the high-speed driving.

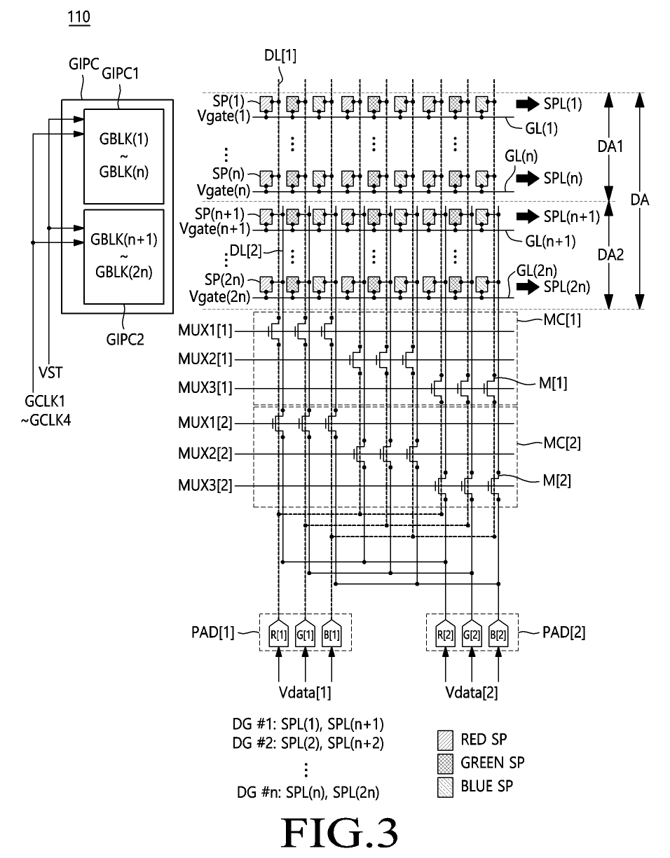

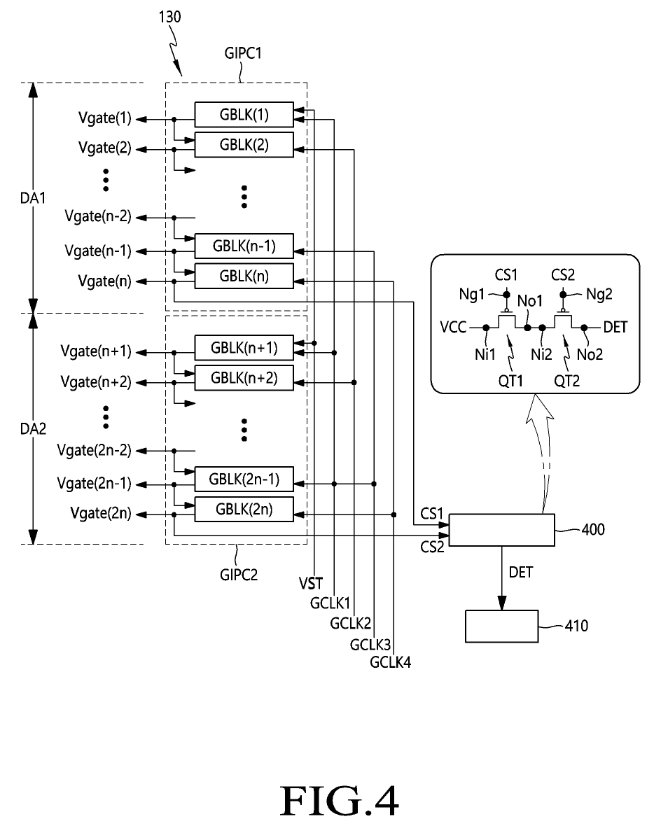

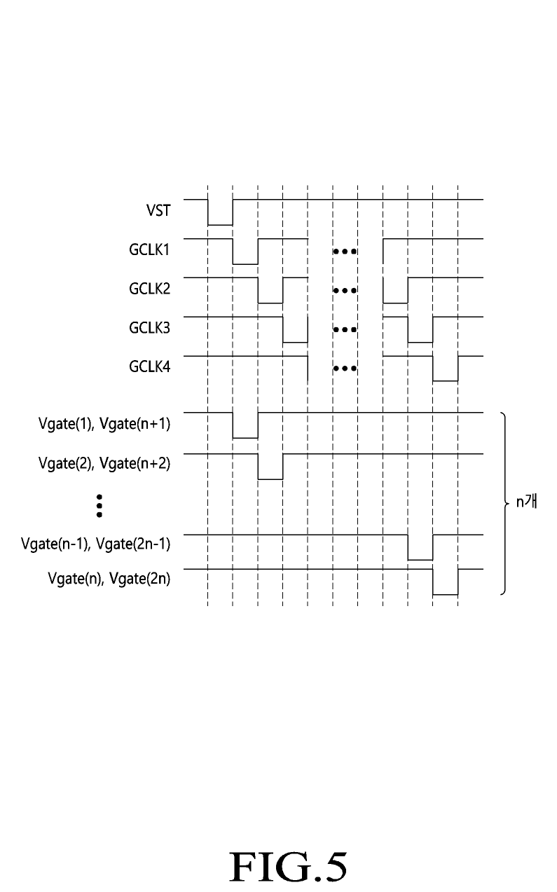

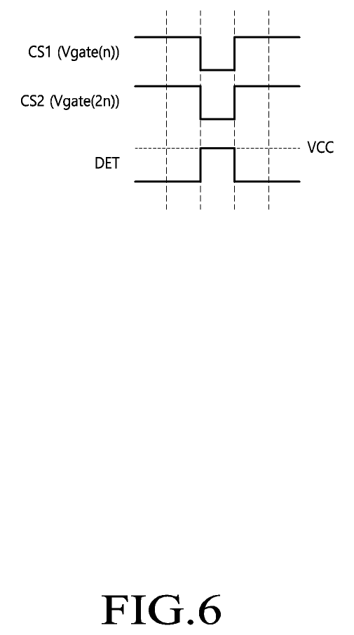

FIG. 3 illustrates an example first high-speed driving system of the display device 100 according to aspects of the present disclosure. FIG. 4 illustrates an example gate driving system of the first high-speed driving system. FIG. 5 is an example gate driving timing diagram of the first high-speed driving system. FIG. 6 is an example detection driving timing diagram of the first high-speed driving system.

Referring to FIG. 3, the display device 100 may include the display panel 110 including first to 2nth subpixel lines (SPL(1) to SPL(2n)) disposed in the display area DA, and the gate driving circuit 130 configured to supply a gate signal Vgate to each of the first to 2nth subpixel lines (SPL(1) to SPL(2n)). For example, the gate driving circuit 130 may be a gate-in-panel circuit GIPC implemented in the GIP structure. Hereinafter, the gate driving circuit 130 may be described as the gate-in-panel circuit GIPC.

Each of the first to 2nth subpixel lines (SPL(1) to SPL(2n)) may include a plurality of subpixels arranged in a first direction (e.g., a row direction or column direction). For example, the first subpixel line SPL(1) may include a plurality of first subpixels SP(1), an nth subpixel line SPL(n) may include a plurality of nth subpixels SP(n), an (n+1)th subpixel line SPL(n+1) may include a plurality of (n+1)th subpixels SP(n+1), and the 2nth subpixel line SPL(2n) may include a plurality of 2nth subpixels SP(2n).

Among the first to 2nth subpixel lines (SPL(1) to SPL(2n)), the first to nth subpixel lines (SPL(1) to SPL(n)) may be arranged in a first display area DA1, and the (n+1)th to 2nth subpixel lines (SPL(n+1) to SPL(2n)) may be arranged in a second display area DA2 different from the first display area DA1.

The display panel 110 may include first to 2nth gate lines (GL(1) to GL(2n)) arranged to correspond to first to 2nth subpixel lines (SPL(1) to SPL(2n)). Each of the first to 2nth gate lines (GL(1) to GL(2n)) may extend in the first direction (e.g., the row direction or column direction).

The display panel 110 may include a plurality of first data lines DL[1] for supplying data signals Vdata[1] to the first to nth subpixel lines (SPL(1) to SPL(n)), and a plurality of second data lines DL[2] for supplying data signals Vdata[2] to the (n+1)th to 2nth subpixel lines (SPL(n+1) to SPL(2n)). Each of the data lines (DL[1] and DL[2]) may be arranged to extend in a second direction (e.g., the column direction or row direction).

The display panel 110 may include a first pad part PAD[1] in which a plurality of first data pads (R[1], G[1], and B[1]) are disposed, and a second pad portion PAD[2] in which a plurality of second data pads (R[2], G[2], and B[2]) are disposed, and may further include a first multiplexing circuit MC[1] and a second multiplexing circuit MC[2].

The first multiplexing circuit MC[1] may include a plurality of first multiplexing transistors M[1]. The plurality of first multiplexing transistors M[1] may be turned on or turned off according to a plurality of first multiplexing control signals (MUX1[1], MUX2[1], and MUX3[1]), and thereby control electrical connections between the plurality of first data lines DL[1] and the plurality of first data pads (R[1], G[1], and B[1]).

For example, the number of the plurality of first data pads (R[1], G[1], and B[1]) may be the same as the number of the plurality of first data lines DL[1]. In another example, as illustrated in FIG. 3, the number of the plurality of first data pads (R[1], G[1], and B[1]) may be less than the number of the plurality of first data lines DL[1]. For example, the plurality of first data pads (R[1], G[1], and B[1]) may be disposed such that one first data pad is disposed to correspond to first data lines connected to subpixels emitting light of a same color (e.g., red subpixels, green subpixels, or blue subpixels). This configuration can provide an advantage of reducing the number of data signal output channels of the data driving circuit 120.

The second multiplexing circuit MC[2] may include a plurality of second multiplexing transistors M[2]. The plurality of second multiplexing transistors M[2] may be turned on or turned off according to a plurality of second multiplexing control signals (MUX1[2], MUX2[2], and MUX3[2]), and thereby control electrical connections between the plurality of second data lines DL[2] and the plurality of second data pads (R[2], G[2], and B[2]).

For example, the number of the plurality of second data pads (R[2], G[2], and B[2]) may be the same as the number of the plurality of second data lines DL[2]. In another example, as illustrated in FIG. 3, the number of the plurality of second data pads (R[2], G[2], and B[2]) may be less than the number of the plurality of second data lines DL[2]. For example, the plurality of second data pads second data pads (R[2], G[2], and B[2]) may be disposed such that one second data pad is disposed to correspond to second data lines connected to subpixels emitting light of a same color (e.g., red subpixels, green subpixels, or blue subpixels). This configuration can provide an advantage of reducing the number of data signal output channels of the data driving circuit 120.

The display device 100 may group the first to 2nth subpixel lines (SPL(1) to SPL(2n)) into first to nth driving groups (DG #1 to DG #n), and thereby can drive the first to nth driving groups (DG #1 to DG #n). This configuration can provide an advantage of enabling high-speed driving. In one or more aspects, the high-speed driving can be implemented through high-scanning rate driving (or high-scanning rate gate driving).

In the display device 100, the first to nth driving groups (DG #1 to DG #n) may be sequentially driven during at least one frame period, and two subpixel lines included in each driving group of the first to nth driving groups (DG #1 to DG #n) may be driven simultaneously or together.

For example, the first to 2nth subpixel lines (SPL(1) to SPL(2n)) may be grouped into the first to nth driving groups (DG #1 to DG #n). Here, n may be a natural number greater than or equal to 2. In this example, each driving group of the first to nth driving groups (DG #1 to DG #n) may include two subpixel lines.

In one or more aspects, example methods of grouping subpixel lines may include a "first grouping method" of grouping two spaced-apart subpixel lines into one driving group, and a "second grouping method" of grouping two adjacent subpixel lines into one driving group.

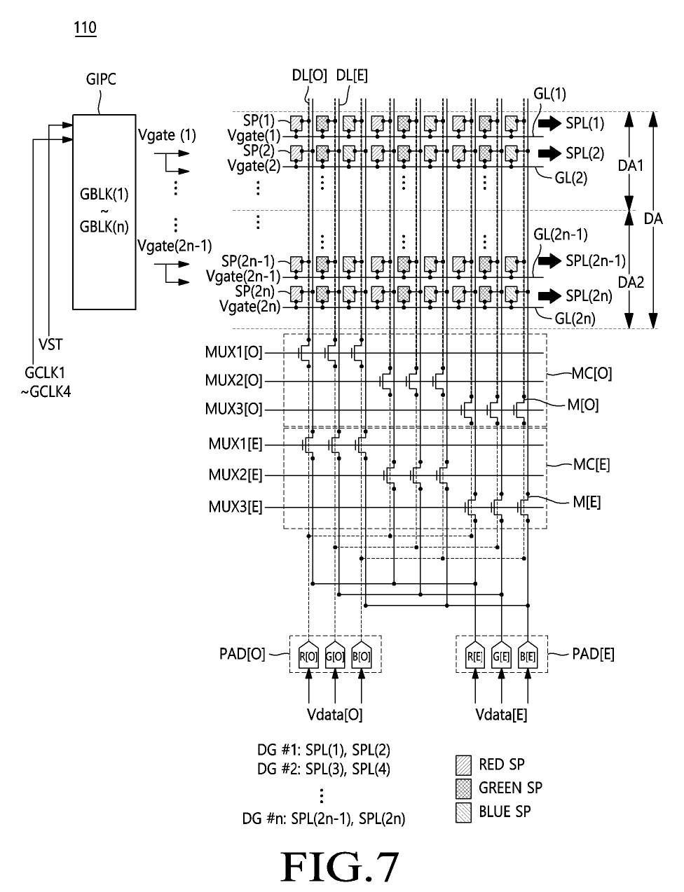

Group driving based on the first grouping method may be referred to as "first group driving," and group driving based on the second grouping method may be referred to as "second group driving.” The first group driving based on the first grouping method is described with reference to FIGS. 3-6, and the second group driving based on the second grouping method is described with reference to FIGS. 7-10.

Referring to FIG. 3, in the first grouping method according to aspects of the present disclosure, two subpixel lines included in each driving group of the first to nth driving groups (DG #1 to DG #n) may be spaced apart from each other. For example, the first driving group (DG #1) may include the first subpixel line (SPL(1)) and the (n+1)th subpixel line (SPL(2)), which are spaced apart from each other. The nth driving group (DG #n) may include the nth subpixel line SPL(n) and the 2nth subpixel line SPL(2n), which are spaced apart from each other.

For example, according to the first grouping method, among two subpixel lines included in each of the first to nth driving groups (DG #1 to DG #n), one subpixel line may be arranged in a first display area DA1 among display areas DA, and the other subpixel line may be arranged in a second display area DA2, which is different from the first display area DA1 among the display areas DA.

Among the first to nth driving groups (DG #1 to DG #n), the first driving group (DG #1) may include the first subpixel line SPL(1) among the first to nth subpixel lines (SPL(1) to SPL(n)), and the (n+1)th subpixel line SPL(n+1) among the (n+1)th to 2nth subpixel lines (SPL(n+1) to SPL(2n)).

The nth driving group (DG #n) may include the nth subpixel line SPL(n) among the first to nth subpixel lines (SPL(1) to SPL(n)), and the 2nth subpixel line SPL(2n) among the (n+1)th to 2nth subpixel lines (SPL(n+1) to SPL(2n)).

Referring to FIGS. 3-5, in one or more aspects, according to the first group driving based on the first grouping method, two subpixel lines included in each of the first to nth driving groups (DG #1 to DG #n) may be supplied with gate signals simultaneously or together. For example, two subpixel lines included in each of the first to nth driving groups (DG #1 to DG #n) may be supplied with identical gate signals. The identical gate signals can be implemented by two gate signals that have a turn-on level voltage at the same timing.

For example, in the first driving group (DG #1), a first gate signal Vgate(1) supplied to the first subpixel line SPL(1) and an (n+1) gate signal Vgate(n+1) supplied to the (n+1)th subpixel line SPL(n+1) may be equal to each other. In another example, in the nth driving group (DG #n), an nth gate signal Vgate(n) supplied to the nth subpixel line SPL(n) and a 2nth gate signal Vgate(2n) supplied to the 2nth subpixel line SPL(2n) may be equal to each other.

For the first group driving based on the first grouping method, the gate-in-panel circuit GIPC may include first and second gate-in-panel circuits (GIPC1 and GIPC2).

The first gate-in-panel circuit GIPC may include first to nth gate driving blocks (GBLK(1) to GBLK(n)) configured to drive the first to nth gate lines (GL(1) to GL(n)). The second gate-in-panel circuit GIPC2 may include (n+1)th to (2n)th gate driving blocks (GBLK(n+1) to GBLK(2n)) configured to drive (n+1)th to (2n)th gate lines (GL(n+1) to GL(2n)).

For the first group driving based on the first grouping method, the first and second gate-in-panel circuits (GIPC1 and GIPC2) may interoperate with each other. To implement this configuration, each of the first and second gate-in-panel circuits (GIPC1 and GIPC2) can be commonly supplied with two or more clock signals (GCLK1-GCLK4), and the first gate-in-panel circuit GIPC among the first and second gate-in-panel circuits (GIPC1 and GIPC2) can be supplied with a start signal VST.

The first and second gate-in-panel circuits (GIPC1 and GIPC2) can generate gate signals (Vgate(1) to (2n)) based on a plurality of clock signals (GCLK1 to 4). The first and second gate-in-panel circuits (GIPC1 and GIPC2) can generate corresponding gate signals having a turn-on level voltage (e.g., a low level voltage in FIG. 5) corresponding to a turn-on level voltage (e.g., a low level voltage in FIG. 5) of clock signals corresponding to corresponding stages.

According to the first group driving based on the first grouping method, image displaying on the display panel 110 may be performed such that when a first image starts to be displayed in the first display area DA1, a second image different from the first image also starts to be displayed in the second display area DA2. For example, image displaying in the first display area DA1 and image displaying in the second display area DA2 may be performed simultaneously or together.

According to the first group driving based on the first grouping method, when the first to nth subpixel lines (SPL(1) to SPL(n)) disposed in the first display area DA1 are sequentially driven, the (n+1) to 2nth subpixel lines (SPL(n+1) to SPL(2n)) disposed in the second display area DA2 may also be sequentially driven. According to this configuration, for example, respective images in the first display area DA1 and the second display area DA2 can be displayed from top to bottom.

Referring to FIG. 4, the display device 100 may include a detection circuit 400 to detect a driving error related to the first group driving based on the first grouping method.

The detection circuit 400 can receive a detection reference voltage VCC and at least one control signal, and output a detection signal DET determined according to at least one control signal (CS1 and/or CS2).

In one or more aspects, when the first group driving based on the first grouping method is performed, the at least one control signal (CS1 and/or CS2) may be one of two gate signals (e.g., an nth gate signal Vgate(n) and a 2nth gate signal Vgate(2n)) applied to two subpixel lines (e.g., the nth subpixel line SPL(n) and the 2nth subpixel line SPL(2n)) included in the nth driving group (DG #n) driven last among the first to nth driving groups (DG #1 to DG #n).

For example, referring to FIGS. 4 and 6, the detection circuit 400 can receive the detection reference voltage VCC, a first control signal CS1, and a second control signal CS2, and output a detection signal DET determined according to the first control signal CS1 and the second control signal CS2.

The first control signal CS1 and the second control signal CS2 may be two gate signals (e.g., the nth gate signal Vgate(n) and the 2nth gate signal Vgate(2n)) applied to two subpixel lines (e.g., the nth subpixel line SPL(n) and the 2nth subpixel line SPL(2n)) included in the nth driving group (DG #n) driven last among the first to nth driving groups (DG #1 to DG #n).

When both the first control signal CS1 and the second control signal CS2 have a turn-on level voltage, the detection signal DET may have a voltage corresponding to the detection reference voltage VCC. When at least one of the first control signal CS1 or the second control signal CS2 has a turn-off level voltage, the detection signal DET may have a voltage different from the detection reference voltage VCC.

In each of the first control signal CS1 and the second control signal CS2, the turn-on level voltage and the turn-off level voltage may be depending on a type (e.g., a n-type or p-type) of a transistor included in a subpixel SP to which a gate signal is applied. For example, when a transistor in a subpixel SP to which a gate signal is applied is an n-type, the turn-on level voltage may be a high-level voltage, and the turn-off level voltage may be a low-level voltage. In another example, when the transistor in the subpixel SP to which the gate signal is applied is a p-type, the turn-on level voltage may be a low-level voltage, and the turn-off level voltage may be a high-level voltage.

For example, the nth driving group (DG #n) driven last among the first to nth driving groups (DG #1 to DG #n) may include the (2n-1)th subpixel line SPL(2n-1) and the 2nth subpixel line SPL(2n). In this example, the first control signal CS1 may be a (2n-1) gate signal Vgate(2n-1) applied to the (2n-1)th subpixel line SPL(2n-1), and the second control signal CS2 may be a 2nth gate signal Vgate(2n) applied to the 2nth subpixel line SPL(2n).

The detection circuit 400 may include a first detection transistor QT1 configured to receive a detection reference voltage VCC and to be turned on or turned off according to the first control signal CS1, and a second detection transistor QT2 configured to be turned on or turned off according to the second control signal CS2. The first and second detection transistors (QT1 and QT2) may be connected in series.

The first detection transistor QT1 may include a first gate node Ng1 to which the first control signal CS1 is applied, a first input node Ni1 to which the detection reference voltage VCC is input, and a first output node No1 electrically connected to the first input node Ni1 according to the first control signal CS1. The second detection transistor QT2 may include a second gate node Ng2 to which the second control signal CS2 is applied, a second input node Ni2 connected to the first output node No1, and a second output node No2 electrically connected to the second input node Ni2 according to the second control signal CS2.

When both the first and second detection transistors (QT1 and QT2) are in a turn-on state, a detection signal DET having the detection reference voltage VCC may be output from the second output node No2 of the second detection transistor QT2. When at least one of the first or second detection transistors (QT1 or QT2) is in a turn-off state, a detection signal DET having a voltage different from the detection reference voltage VCC may be output from the second output node No2.

Referring to FIG. 4, the display device 100 may further include a group driving error response device 410 configured to perform suitable actions for a group driving error based on a detection signal DET output from the detection circuit 400. For example, the group driving error response device 410 may be the controller 140 of FIG. 1.

When the detection signal DET does not correspond to a predefined normal state (e.g., a state having a detection reference voltage VCC), the group driving error response device 410 can determine that a group driving error has occurred and take predefined response actions. For example, the group driving error response device 410 can cause a black screen to be presented on the display panel 110, a power-off process to be performed, or a rebooting process to be perform.

As described above, discussions have been provided for the first high-speed driving through the first group driving based on the first grouping method. Discussions that follow are provided for an example second high-speed driving through second group driving based on the second grouping method. Hereinafter, discussions for features equal, substantially equal, or similar to the features described above may be omitted.

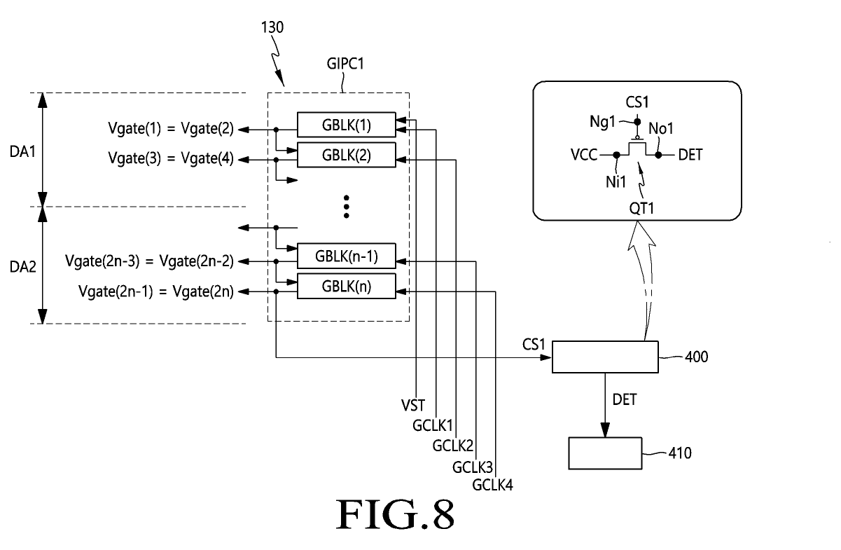

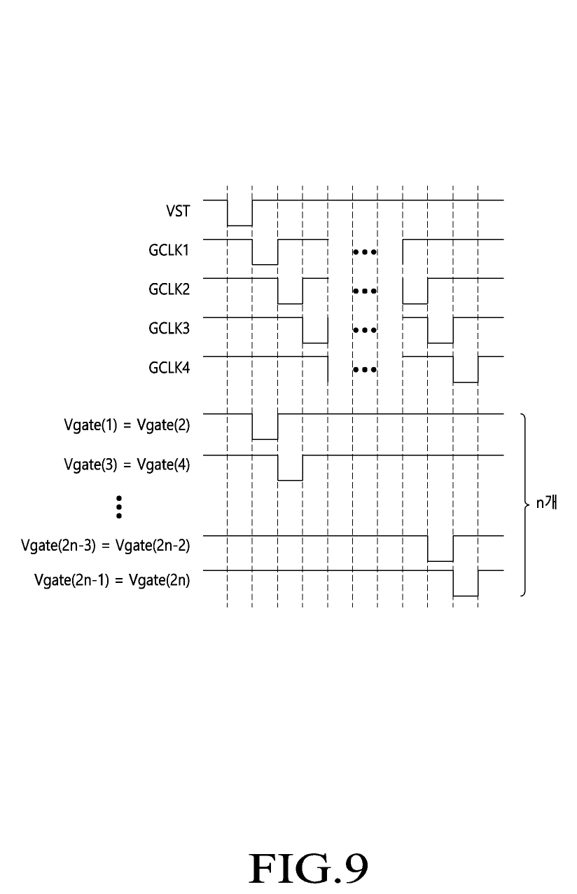

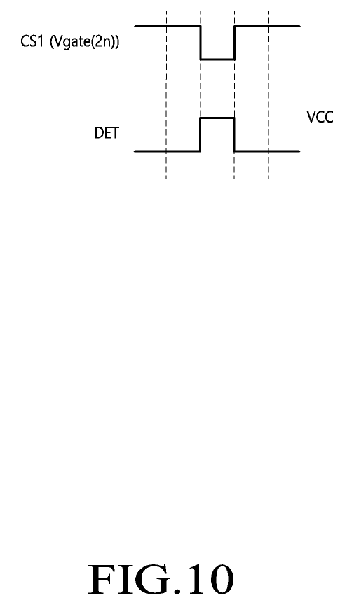

FIG. 7 illustrates an example second high-speed driving system of the display device 100 according to aspects of the present disclosure. FIG. 8 illustrates an example gate driving system of the second high-speed driving system. FIG. 9 is an example gate driving timing diagram of the second high-speed driving system. FIG. 10 is an example detection driving timing diagram of the second high-speed driving system.

Referring to FIG. 7, in the second grouping method according to aspects of the present disclosure, two subpixel lines included in each of first to nth driving groups (DG #1 to DG #n) may be disposed adjacent to each other. For example, all two subpixel lines included in each of the first to nth driving groups (DG #1 to DG #n) may be disposed in the first display area DA1 or in the second display area DA2.

For example, the first driving group (DG #1) may include a first subpixel line SPL(1) disposed in the first display area DA1 and a second subpixel line SPL(2) disposed in the first display area DA1. For example, the nth driving group (DG #n) may include a (2n-1)th subpixel line SPL(2n-1) disposed in the second display area DA2 and a 2nth subpixel line SPL(2n) disposed in the second display area DA2.

According to the second grouping method, for example, the display panel 110 may further include first to 2nth gate lines (GL(1) to GL(2n)) arranged to correspond to the first to 2nth subpixel lines (SPL(1) to SPL(2n)). In another example, the display panel 110 may further include n gate lines arranged to correspond to the first to nth driving groups (DG #1 to DG #n). Each of the n gate lines may be included in a respective one of the first to nth driving groups (DG #1 to DG #n), be arranged between two subpixel lines disposed adjacent to each other, and be connected to both subpixel lines.

The display panel 110 may include a plurality of first data lines DL[O] for supplying data signals Vdata[O] to odd-numbered subpixel lines (SPL(1), SPL(3), …, and SPL(2n-1)) among the first to 2nth subpixel lines (SPL(1) to SPL(2n)), and a plurality of second data lines DL[E] for supplying data signals Vdata[E] to even-numbered subpixel lines (SPL(2), SPL(4), …, and SPL(2n)) among the first to 2nth subpixel lines (SPL(1) to SPL(2n)).

The display panel 110 may include a first pad part PAD[O] in which a plurality of first data pads (R[O], G[O], and B[O]) are disposed, and a second pad part PAD[E] in which a plurality of second data pads (R[E], G[E], and B[E]) are disposed, and further include a first multiplexing circuit MC[O] and a second multiplexing circuit MC[E].

The first multiplexing circuit MC[O] may include a plurality of first multiplexing transistors M[O]. The plurality of first multiplexing transistors M[O] may be turned on and turned off according to a plurality of first multiplexing control signals (MUX1[O], MUX2[O], and MUX3[O]), and thereby control electrical connections between the plurality of first data lines DL[O] and the plurality of first data pads (R[O], G[O], and B[O]).

For example, the number of the plurality of first data pads (R[O], G[O], and B[O]) may be the same as the number of the plurality of first data lines DL[O]. In another example, as illustrated in FIG. 7, the number of the plurality of first data pads (R[O], G[O], and B[O]) may be less than the number of the plurality of first data lines DL[O]. For example, the plurality of first data pads (R[O], G[O], and B[O]) may be disposed such that one first data pad is disposed to correspond to first data lines connected to subpixels emitting light of a same color (e.g., red subpixels, green subpixels, or blue subpixels). This configuration can provide an advantage of reducing the number of data signal output channels of the data driving circuit 120.

The second multiplexing circuit MC[E] may include a plurality of second multiplexing transistors M[E]. The plurality of second multiplexing transistors M[E] may be turned on and turned off according to a plurality of second multiplexing control signals (MUX1[E], MUX2[E], and MUX3[E]), and thereby control electrical connections between the plurality of second data lines DL[E] and the plurality of second data pads (R[E], G[E], and B[E]).

For example, the number of the plurality of second data pads (R[E], G[E], and B[E]) may be the same as the number of the plurality of second data lines DL[E]. In another example, as illustrated in FIG. 7, the number of the plurality of second data pads (R[E], G[E], and B[E]) may be less than the number of the plurality of second data lines DL[E]. For example, the plurality of second data pads (R[E], G[E], and B[E]) may be disposed such that one second data pad is disposed to correspond to second data lines connected to subpixels emitting light of a same color (e.g., red subpixels, green subpixels, or blue subpixels). This configuration can provide an advantage of reducing the number of data signal output channels of the data driving circuit 120.

The first to 2nth subpixel lines (SPL(1) to SPL(2n)) may be grouped into first to nth driving groups (DG #1 to DG #n). The first to nth driving groups (DG #1 to DG #n) may be sequentially driven during at least one frame period, and two subpixel lines included in each of the first to nth driving groups (DG #1 to DG #n) may be driven simultaneously or together.

Referring to FIGS. 7-9, in one or more aspects, according to the second group driving based on the second grouping method, two subpixel lines included in each of the first to nth driving groups (DG #1 to DG #n) can be supplied with an equal gate signal.

The first driving group (DG #1) may include the first subpixel line SPL(1) and the second subpixel line SPL(2). A first gate signal Vgate(1) supplied to the first subpixel line SPL(1) and a second gate signal Vgate(2) supplied to the second subpixel line SPL(2) may be equal to each other.

A second driving group (DG #2) may include a third subpixel line SPL(3) and a fourth subpixel line SPL(4). A third gate signal Vgate(3) supplied to the third subpixel line SPL(3) and a fourth gate signal Vgate(4) supplied to the fourth subpixel line SPL(4) may be equal to each other.

An (n-1)th driving group (DG #(n-1)) may include a (2n-3)th subpixel line SPL(2n-3) and a (2n-2)th subpixel line SPL(2n-2). A (2n-3)th gate signal Vgate(2n-3) supplied to the (2n-3)th subpixel line SPL(2n-3) and a (2n-2)th gate signal Vgate(2n-2) supplied to the (2n-2)th subpixel line SPL(2n-2) may be equal to each other.

The nth driving group (DG #n) may include the (2n-1)th subpixel line SPL(2n-1) and the 2nth subpixel line SPL(2n). A (2n-1)th gate signal Vgate(2n-1) supplied to the (2n-1)th subpixel line SPL(2n-1) and a 2nth gate signal Vgate(2n) supplied to the 2nth subpixel line SPL(2n) may be equal to each other.

The display panel 110 may further include first to 2nth gate lines (GL(1) to GL(2n)) arranged to correspond to the first to nth subpixel lines (SPL(1) to SPL(n)).

The gate-in-panel circuit GIPC may include n gate driving blocks (GBLK(1) to GBLK(n)) configured to drive odd-numbered gate lines (GL(1), GL(3), ...) or even-numbered gate lines (GL(2), GL(4), ...) among the first to 2nth gate lines (GL(1) to GL(2n)).

A gate signal output from each of the n gate driving blocks (GBLK(1) to GBLK(n)) may be supplied to two gate lines (or one common gate line) connected to two subpixel lines included in one driving group.

The gate-in-panel circuit GIPC can be supplied with a plurality of clock signals (GCLK1 to GCLK4) and a start signal VST.

The gate-in-panel circuit GIPC can generate gate signals (“Vgate(1) to Vgate(2n)” or “Vgate(1), Vgate(3), …, Vgate(2n-1)” or “Vgate(2), Vgate(4), …, Vgate(2n)”) based on the plurality of clock signals (GCLK1 to GCLK4). The gate-in-panel circuit GIPC can generate a corresponding gate signal having a turn-on level voltage (e.g., a low level voltage in FIG. 9) corresponding to a turn-on level voltage (e.g., a low level voltage in FIG. 9) of a clock signal corresponding to a corresponding stage.

In one or more aspects, according to the second group driving based on the second grouping method, after a first image is displayed in the first display area DA1, a second image different from the first image may be displayed in the second display area DA2.

In one or more aspects, according to the second group driving based on the second grouping method, after (n/2) driving groups resulting from grouping the first to nth subpixel lines (SPL(1) to SPL(n)) disposed in the first display area DA1 are sequentially driven, (n/2) driving groups resulting from grouping the (n+1)th to 2nth subpixel lines (SPL(n+1) to SPL(2n)) disposed in the second display area DA2 may be sequentially driven. According to this configuration, an image of the first display area DA1 may be displayed first, and an image of the second display area DA2 may be displayed subsequently.

Referring to FIGS. 8 and 10, a detection circuit 400 can receive a detection reference voltage VCC and a first control signal CS1, and output a detection signal DET determined according to the first control signal CS1.

The first control signal CS1 may be one of two gate signals (e.g., the (2n-1)th gate signal Vgate(2n-1) or the 2nth gate signal Vgate(2n)) applied to two subpixel lines included in the nth driving group (DG #n) driven last among the first to nth driving groups (DG #1 to DG #n).

When the first control signal CS1 has a turn-on level voltage, the detection signal DET may have a voltage corresponding to the detection reference voltage VCC, and when the first control signal CS1 is a turn-off level voltage, the detection signal DET may have a voltage different from the detection reference voltage VCC.

The first control signal CS1 may be one of the (2n-1-th gate signal Vgate(2n-1) and the 2nth gate signal Vgate(2n) applied to the (2n-1)th subpixel line SPL(2n-1) and the 2nth subpixel line SPL(2n) included in the nth driving group (DG #n).

The detection circuit 400 may include a first detection transistor QT1 configured to be turned on or turned off according to the first control signal CS1.

The first detection transistor QT1 may include a first gate node Ng1 to which the first control signal CS1 is applied, a first input node Ni1 to which the detection reference voltage VCC is input, and a first output node No1 electrically connected to the first input node Ni1 according to the first control signal CS1.

When the first detection transistor QT1 is in a turn-on state, a detection signal DET having the detection reference voltage VCC may be output from the first output node No1 of the first detection transistor QT1. When the first detection transistor QT1 is in a turn-off state, a detection signal DET having a voltage different from the detection reference voltage VCC may be output from the first output node No1.

When the detection signal DET does not correspond to a predefined normal state (e.g., a state having a detection reference voltage VCC), a group driving error response device 410 can determine that a group driving error has occurred and take predefined response actions. For example, the group driving error response device 410 can cause a black screen to be presented on the display panel 110, a power-off process to be performed, or a rebooting process to be perform.

As described above, discussions have been provided for high-speed driving based on group driving according to aspects of the present disclosure. Hereinafter, discussions are provided for a multi-view display technology based on high-speed driving according to aspects of the present disclosure. In discussions that follow, reference is also made to the configurations of FIGS. 1-10.

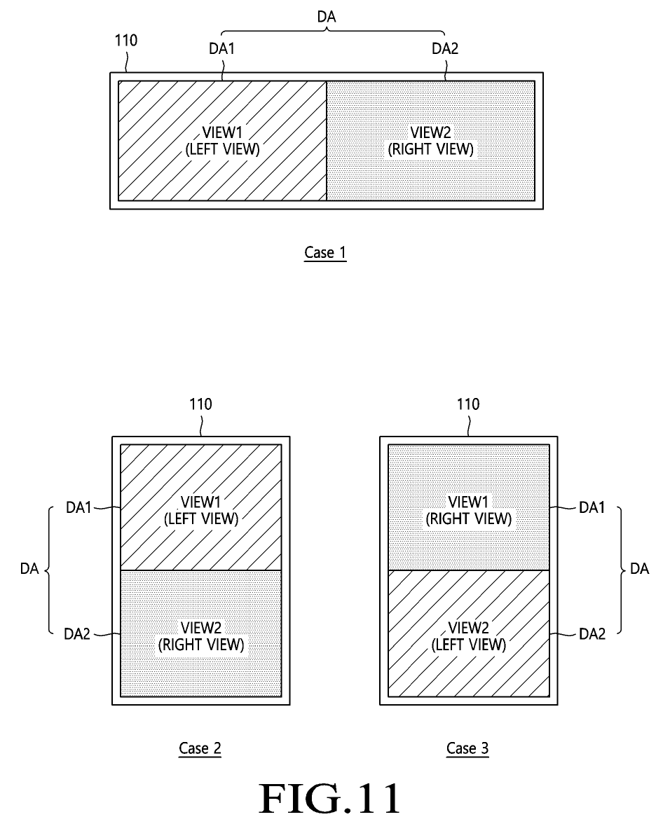

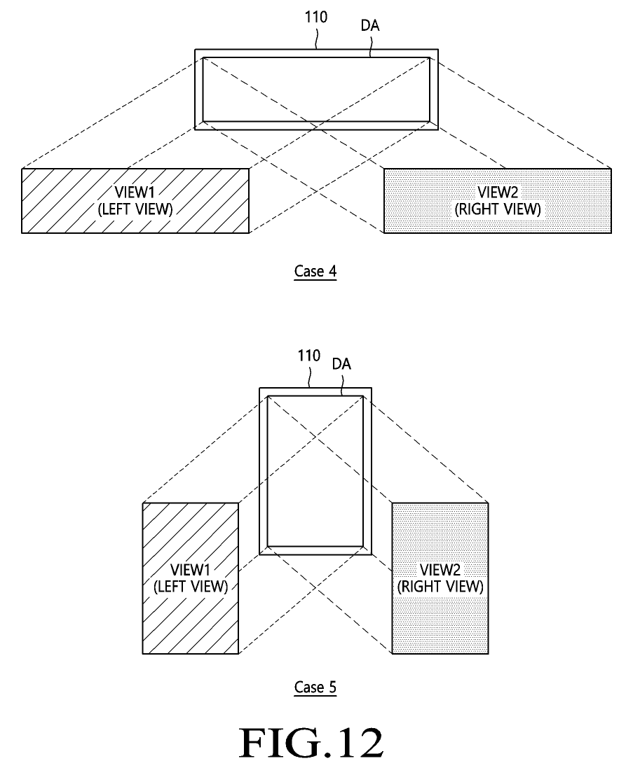

FIGS. 11 and 12 illustrate examples multi-view displays of the display device 100 according to aspects of the present disclosure.

Referring to FIG. 11, the display area DA may include first and second display areas (DA1 and DA2). An image (or video) displayed in the first display area DA1 may be referred to as a first view image VIEW1, and an image (or video) displayed in the second display area DA2 may be referred to as a second view image VIEW2. The first view image VIEW1 and the second view image VIEW2 may be images (or videos) visible when the display panel 110 is viewed in different directions, and be different images from each other. The first view image VIEW1 may also be referred to as a first view screen, and the second view image VIEW2 may also be referred to as a second view screen.

As in a first case Case 1, the display panel 110 may have a horizontally elongated structure. In this case, the first display area DA1 may be located to the left of the second display area DA2.

In the first case, when a first user located on the left side of the display panel 110 views the display panel 110, the first view image VIEW1 displayed in the first display area DA1 may be viewed to the first user, and the second view image VIEW2 displayed in the second display area DA2 may not be viewed to the first user. When a second user located on the right side of the display panel 110 views the display panel 110, the first view image VIEW1 displayed in the first display area DA1 may not be viewed to the second user, and the second view image VIEW2 displayed in the second display area DA2 may be viewed to the second user.

In the first case, the first view image VIEW1 may be a left image LEFT VIEW that may be viewable when the first user located on the left side of the display panel 110 views the display panel 110. The second view image VIEW2 may be a right image RIGHT VIEW that may be viewable when the second user located on the right side of the display panel 110 views the display panel 110.

As in second and third Cases 2 and 3, the display panel 110 may have a vertically elongated structure. In these cases, the first display area DA1 may be located over the second display area DA2.

In the second case Case 2, when a first user located on the left side of the display panel 110 views the display panel 110, the first view image VIEW1 may be viewed to the first user, and the second view image VIEW2 displayed in the second display area DA2 may not be viewed to the first user. When a second user located on the right side of the display panel 110 views the display panel 110, the first view image VIEW1 displayed in the first display area DA1 may not be viewed to the second user, and the second view image VIEW2 displayed in the second display area DA2 may be viewed to the second user. In the second case, the first view image VIEW1 may be a left image LEFT VIEW. The second view image VIEW2 may be a right image RIGHT VIEW.

In the third case Case 3, when a first user located on the left side of the display panel 110 views the display panel 110, the first view image VIEW1 displayed in the first display area DA1 may not be viewed to the first user, and the second view image VIEW2 displayed in the second display area DA2 may be viewed to the first user. When a second user located on the right side of the display panel 110 views the display panel 110, the first view image VIEW1 displayed in the first display area DA1 may be viewed to the second user, and the second view image VIEW2 displayed in the second display area DA2 may not be viewed to the second user. In the third case, the first view image VIEW1 may be a right image RIGHT VIEW. The second view image VIEW2 may be a left image LEFT VIEW.

In the first to third cases Cases 1 to 3, the first display area DA1 and the second display area DA2 may be the first display area DA1 and the second display area DA2 of FIGS. 3-10.

As in a fourth case Case 4, the display panel 110 may have a horizontally elongated structure. Both the first view image VIEW1 and the second view image VIEW2 may be displayed across all of the display area DA of the display panel 110.

In the fourth case Case 4, when a first user located on the left side of the display panel 110 views the display panel 110, the first user may view the first view image VIEW1 across all of the display area DA, but may not view the second view image VIEW2.

As in a first case Case 5, the display panel 110 may have a vertically elongated structure. Both the first view image VIEW1 and the second view image VIEW2 may be displayed across all of the display area DA of the display panel 110.

In the fifth case Case 5, when a first user located on the left side of the display panel 110 views the display panel 110, the first user may view the first view image VIEW1 on the display area DA, but may not view the second view image VIEW2.

In the fourth and fifth cases Cases 4 and 5, the first view image VIEW1 and the second view image VIEW2 may be images displayed across all of the display area DA. The first view image VIEW1 may be a left image LEFT VIEW that may be viewable when the first user located on the left side of the display panel 110 views the display panel 110. The second view image VIEW2 may be a right image RIGHT VIEW that may be viewable when the second user located on the right side of the display panel 110 views the display panel 110.

The display device 100, to which the multi-view display technology illustrated in FIGS. 11 and 12 is applied, may be a display device installed in a vehicle. For example, this may be a display device installed in the center fascia of a vehicle dashboard. In this example, a first user located on the left side of the display panel 110 may be a user (e.g., a driver or a passenger other than the driver) in a seat to the left of the center fascia (e.g., a driver's seat or a seat next to the driver's seat), and a second user located on the right side of the display panel 110 may be a user (e.g., the passenger other than the driver or the driver) in a seat to the right of the center fascia (e.g., the driver's seat or the seat next to the driver's seat).

For example, the first view image VIEW1 may be a vehicle-and-driving-related screen viewed by the driver, and the second view image VIEW2 may be a non-driver screen viewed by the passenger next to the driver. For example, the vehicle-and-driving-related screen may include a navigation screen, a vehicle setting screen, a vehicle information screen, or the like. The non-driver screen may be a screen not interfering with driving of a vehicle or unrelated to the driving of the vehicle, such as a game screen, a content screen, or the like.

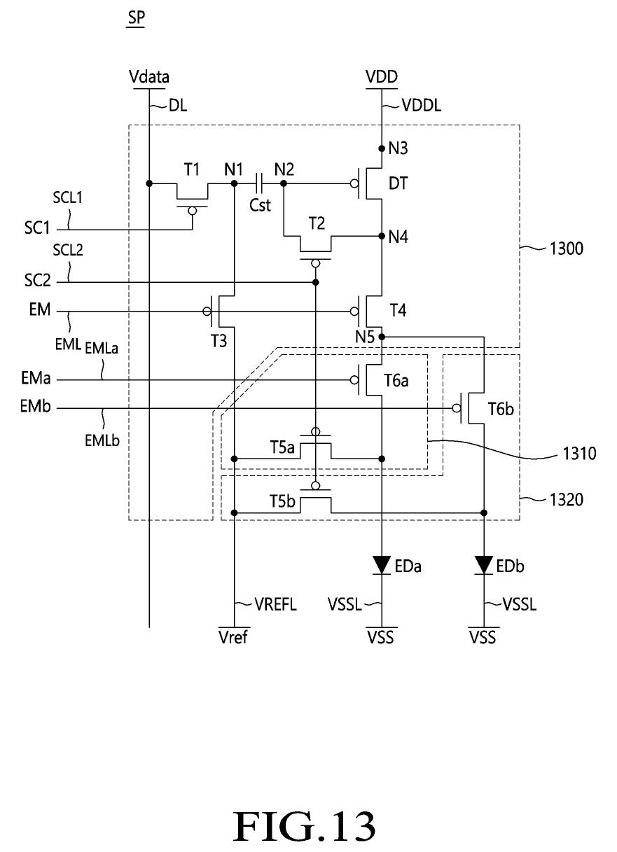

FIG. 13 illustrates an example equivalent circuit for a subpixel SP of the display device 100 according to aspects of the present disclosure. In discussions that follow, reference is also made to the configurations of FIGS. 1-12.

Referring to FIG. 13, each of a plurality of subpixels SP may include a first light emitting element EDa and a second light emitting element EDb, and a subpixel circuit SPC for driving at least one of the first or second light emitting element (EDa or EDb). According to this configuration, the display device 100 can implement a multi-view display function.

The subpixel circuit SPC may selectively drive one of the first and second light emitting elements (EDa and EDb) or alternately drive the first and second light emitting elements (EDa and EDb). To implement this configuration, the subpixel circuit SPC may include a common circuit 1300 involved in driving both the first light emitting element EDa and the second light emitting element EDb, a first individual circuit 1310 involved in driving the first light emitting element EDa, and a second individual circuit 1320 involved in driving the second light emitting element EDb.

The common circuit 1300 may include a common transistor configured to be turned on during a driving period of the first light emitting element EDa and a driving period of the second light emitting element EDb. Referring to the example of FIG. 13, the common transistor may include a driving transistor DT and first to fourth transistors (T1 to T4).

The first individual circuit 1310 may include at least one first individual transistor configured to be turned on during a driving period of the first light emitting element EDa. Referring to the example of FIG. 13, the at least one first individual transistor may include a fifth transistor T5a and a sixth transistor T6a.

The second individual circuit 1320 may include at least one second individual transistor configured to be turned on during a driving period of the second light emitting element EDb. Referring to the example of FIG. 13, the at least one second individual transistor may include a seventh transistor T5b and an eighth transistor T6b.

To configure a multi-view display of a desired structure, a driving time (e.g., an emission time) of each of the first light emitting element EDa and the second light emitting element EDb can be controlled. A second electrode (e.g., a common electrode or a cathode electrode) of each of the first light emitting element EDa and the second light emitting element EDb may be electrically connected to a low driving voltage line VSSL to which a low driving voltage VSS is applied. Here, the multi-view display of the desired structure may be one of Cases 1 to 5 illustrated in FIGS. 11 and 12 or another structure.

When a multi-view display is configured as the first to third cases Cases 1 to 3 of FIG. 11, and a corresponding subpixel SP is disposed in the first display area DA1, the first light emitting element EDa may be a driving light emitting element configured to emit light and involve in forming the first view image VIEW1, and the second light emitting element EDb may be a non-driving light emitting element configured not to emit light.

When a multi-view display is configured as the first to third cases Cases 1 to 3 of FIG. 11, and a corresponding subpixel SP is disposed in the second display area DA2, the second light emitting element EDb may be a driving light emitting element configured to emit light and involve in forming the second view image VIEW2, and the first light emitting element EDa may be a non-driving light emitting element configured not to emit light.

When a multi-view display is configured as the fourth and fifth cases Cases 4 and 5 of FIG. 12, both the first light emitting element EDa and the second light emitting element EDb of each subpixel SP may be driving light emitting elements. For example, the first light emitting element EDa of each subpixel SP may be a driving light emitting element configured to emit light and involve in forming the first view image VIEW1, and the second light emitting element EDb of each subpixel SP may be a driving light emitting element configured to emit light and involve in forming the second view image VIEW2.

The subpixel circuit SPC may include a plurality of electrical nodes, such as first to fifth nodes (N1 to N5).

The common circuit 1300 may include a driving transistor DT connected between the third node N3 and the fourth node N4, a first transistor T1 connected between a data line DL and the first node N1, a second transistor T2 connected between the second node N2 and the fourth node N4, a third transistor T3 connected between a reference voltage line VREFL and the first node N1, and a fourth transistor T4 connected between the fourth node N4 and the fifth node N5.

The driving transistor DT may be turned on or off depending on a voltage of the second node N2. When the driving transistor DT is turned on, the driving transistor DT can electrically connect the third node N3 and the fourth node N4 to each other. The second node N2 may electrically correspond to the gate node of the driving transistor DT, the third node N3 may electrically correspond to the source node or drain node of the driving transistor DT, and the fourth node N4 may electrically correspond to the drain node or source node of the driving transistor DT. The third node N3 may be electrically connected to a high driving voltage line VDDL to which a high driving voltage VDD is applied.

The first transistor T1 may be turned on or off depending on a first scan signal SC1. When the first transistor T1 is turned on, the first transistor T1 can electrically connect the data line DL and the first node N1 to each other. Here, the data line DL may be one of the data lines in FIGS. 3 or 7 . The gate node of the first transistor T1 may be electrically connected to the first scan line SCL1 to which the first scan signal SC1 is applied. Here, the first scan line SCL1 may be one of the gate lines in FIGS. 3 or 7 . The first scan signal SC1 may be the gate signals in FIGS. 3 or 7 .

The second transistor T2 may be turned on or off depending on a second scan signal SC2. When the second transistor T2 is turned on, the second transistor T2 can electrically connect the second node N2 and the fourth node N4 to each other. The gate node of the second transistor T2 may be electrically connected to a second scan line SCL2 to which the second scan signal SC2 is applied.

The third transistor T3 may be turned on or off depending on a main emission control signal EM. When the third transistor T3 is turned on, the third transistor T3 can electrically connect the first node N1 and the reference voltage line VREFL to each other. The third transistor T3 may be connected to the first and second individual circuits (1310 and 1320). The gate node of the third transistor T3 may be electrically connected to a main emission control signal line EML to which the main emission control signal EM is applied. The drain node or source node of the third transistor T3 may be electrically connected to the reference voltage line VREFL to which a reference voltage Vref is applied.

The fourth transistor T4 may be turned on or off depending on the main emission control signal EM. When the fourth transistor T4 is turned on, the fourth transistor T4 can electrically connect the fourth node N4 and the fifth node N5 to each other. The fourth transistor T4 may be connected to the first and second individual circuits (1310 and 1320). The gate node of the fourth transistor T4 may be electrically connected to the main emission control signal line EML to which the main emission control signal EM is applied. According to this configuration, the fourth transistor T4 may be turned on or turned off together with the third transistor T3.

The common circuit 1300 may further include a storage capacitor Cst formed between the first node N1 and the second node N2. The storage capacitor Cst may be charged with a desired amount of charge by a desired voltage difference formed between two ends or terminals (N1 and N2) according to a data signal Vdata. A voltage charged at the storage capacitor Cst can be used to enable the first light emitting element EDa or the second light emitting element EDb to emit light.

The first individual circuit 1310 may include the fifth transistor T5a connected between the reference voltage line VREFL and a first electrode (e.g., an anode electrode or a pixel electrode) of the first light emitting element EDa, and the sixth transistor T6a connected between the fifth node and the first electrode of the first light emitting element EDa.

The fifth transistor T5a may be turned on or off according to the second scan signal SC2. When the fifth transistor T5a is turned on, the fifth transistor T5a can electrically connect the reference voltage line VREFL and the first electrode of the first light emitting element EDa. The fifth transistor T5a can transfer the reference voltage VREF to the first electrode of the first light emitting element EDa, and thereby reset a voltage of the first electrode of the first light emitting element EDa to the reference voltage VREF. The gate node of the fifth transistor T5a may be electrically connected to the second scan line SCL2 to which the second scan signal SC2 is applied. According to this configuration, the fifth transistor T5a may be turned on or turned off together with the second transistor T2 included in the common circuit 1300.

The sixth transistor T6a may be turned on or off according to a first emission control signal EMa. When the sixth transistor T6a is turned on, the sixth transistor T6a can electrically connect the fifth node N5 and the first electrode of the first light emitting element EDa. The sixth transistor T6a may be turned on together with the fourth transistor T4 and can form a path allowing the driving transistor DT to supply a driving current to the first light emitting element EDa.

The second individual circuit 1320 may include the seventh transistor T5b connected between the reference voltage line VREFL and a first electrode of the second light emitting element EDb, and the eighth transistor T6b connected between the fifth node and the first electrode of the second light emitting element EDb.

The seventh transistor T5b may be turned on or off according to the second scan signal SC2. When the seventh transistor T5b is turned on, the seventh transistor T5b can electrically connect the reference voltage line VREFL and the first electrode (e.g., the anode electrode) of the second light emitting element EDb. The seventh transistor T5b can transfer the reference voltage VREF to the first electrode of the second light emitting element EDb, and thereby reset a voltage of the first electrode of the second light emitting element EDb to the reference voltage VREF. The gate node of the seventh transistor T5b can be electrically connected to the second scan line SCL2 to which the second scan signal SC2 is applied. According to this configuration, the seventh transistor T5b may be turned on or off together with the second transistor T2 included in the common circuit 1300. Further, the seventh transistor T5b may be turned on or off together with the fifth transistor T5a included in the first individual circuit 1310.

The eighth transistor T6b may be turned on or off according to a second emission control signal EMb. When the eighth transistor T6b is turned on, the eighth transistor T6b can electrically connect the fifth node N5 and the first electrode of the second light emitting element EDb. The eighth transistor T6b may be turned on together with the fourth transistor T4 and can form a path allowing the driving transistor DT to supply a driving current to the second light emitting element EDb.

The fifth transistor T5a and the seventh transistor T5b may be turned on or off together. For implement a multi-view display, only one of the sixth transistor T6a and the eighth transistor T6b may be selectively turned on, or the sixth transistor T6a and the eighth transistor T6b may be alternately turned on.

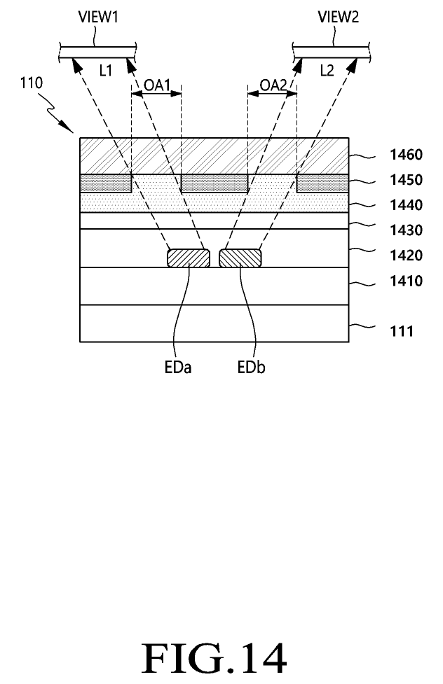

FIG. 14 is an example cross-sectional view for an area of the display panel 110 according to aspects of the present disclosure. For example, FIG. 14 may illustrate an area in which one subpixel SP is disposed. In discussions that follow, reference is also made to the configurations of FIGS. 1-13.

The display panel 110 may include a substrate 111, a transistor formation layer 1410, an encapsulation layer 1420, a touch sensor layer 1430, and a protection layer 1440.

The transistor formation layer 1410 may be a layer in which various transistors (DT, T1 to T4, T5a, T6a, T5b, and T6b) included in the subpixel SP of FIG. 13 are disposed, and include a plurality of insulating layers, at least one metal layer, and at least one semiconductor material layer (e.g., an active layer).

The first light emitting element EDa and the second light emitting element EDb may be disposed in the transistor formation layer 1410.

The encapsulation layer 1420 may be disposed on the first light emitting element EDa and the second light emitting element EDb and can prevent the first light emitting element EDa and the second light emitting element EDb from being exposed to moisture, oxygen, and the like.

The touch sensor layer 1430 may be disposed on the encapsulation layer 1420 and include at least one touch metal layer and at least one touch insulation layer for forming a touch sensor. Touch metal patterns by which the touch sensor is configured may be disposed in the at least one touch metal layer. The touch metal patterns may not overlap with the first light emitting element EDa and the second light emitting element EDb and be formed from a mesh having a conductive grid structure with a plurality of openings (which may be referred to as a mesh type or mesh shape). For example, respective portions of two or more of the plurality of openings may overlap with the first light emitting element EDa and the second light emitting element EDb.

The protection layer 1440 may be disposed on the touch sensor layer 1430.

The display panel 110 may further include a shielding layer 1450 (which may be referred to as a light shielding layer) disposed in a patterned shape on the protection layer 1440. The shielding layer 1450 can adjust a direction in which light emitted from each of the first and second light emitting elements (EDa, EDb) travels. For example, light emitted from the first light emitting element EDa may travel outwards in a different direction from light emitted from the second light emitting element EDb by the adjustment of the shielding layer 1450.

The shielding layer 1450 may have two openings (OA1 and OA2) for each area in which a respective one of a plurality of subpixels SP is located. The two openings (OA1 and OA2) may include a first opening OA1 through which first light L1 emitted from the first light emitting element EDa passes, and a second opening OA2 through which second light L2 emitted from the second light emitting element EDb passes.

According to the multi-view display method, the first light L1 passing through the corresponding first opening OA1 in each of a plurality of subpixels SP disposed in a first area may form a first view image VIEW1. Here, the first area may be the first display area DA1, the second display area DA2, or the display area DA as discussed above.

Depending on the multi-view display method, the second light L2 passing through the corresponding second opening OA2 in each of a plurality of subpixels SP disposed in a second area may form a second view image VIEW2. Here, the second area may be a different area from or the same area as the first area, and be the second display area DA2, the first display area DA1, or the display area DA.

A location where the first opening OA1 is formed in the shielding layer 1450 may be a location where a first user can view the first view image VIEW1 when viewing the display panel 110 at a first location. Here, the first location may be a leftward, rightward, upward, or downward location from, or of, the display panel 110. For example, the first location may be a driver's seat in a vehicle or a passenger seat next to the driver's seat.

A location where the second opening OA2 is formed in the shielding layer 1450 may be a location where a second user can view the second view image VIEW2 when viewing the display panel 110 at a second location. Here, the second location is a location different from the first location, and may be a leftward, rightward, upward, or downward location from, or of, the display panel 110. For example, the second location may be a driver's seat in a vehicle or a passenger seat next to the driver's seat.

A thickness of the shielding layer 1450 may be designed to allow light to pass in a desired direction.

The touch metal patterns may vertically overlap with the first and second openings (OA1 and OA2) of the shielding layer 1450. That is, the touch metal patterns may overlap with the shielding layer 1450. This configuration can allow light emitted from light emitting elements to normally travel.

A thickness of the shielding layer 1450 may be designed to allow light to pass in a desired direction.

The shielding layer 1450 may include a non-metallic material and be an insulating layer. This configuration can enable touch sensing to be normally performed.

The display panel 110 may further include a polarizing layer 1460 disposed on the shielding layer 1450.

A plurality of subpixels SP disposed in the display panel 110 may include a plurality of subpixels disposed in a first display area DA1 among the display areas DA, and a plurality of subpixels disposed in a second display area DA2 among the display areas DA.

For example, the plurality of subpixels disposed in the first display area DA1 may be subpixels included in the first to nth subpixel lines (SPL(1) to SPL(n)) disposed in the first display area DA1 in the examples of FIGS. 3 and 7. The plurality of subpixels disposed in the second display area DA2 may be subpixels included in the (n+1)th to 2nth subpixel lines (SPL(n+1) to SPL(2n)) disposed in the second display area DA2 in the examples of FIGS. 3 and 7.

When a multi-view display is implemented as one of the first to third cases Cases 1 to 3 of FIG. 11, a first view image VIEW1 may be formed in the first display area DA1 by light emitted from the first light emitting element EDa among the corresponding first and second light emitting element EDa and EDb included in each of a plurality of subpixels disposed in the first display area DA1, and a second view image VIEW2 may be formed in the second display area DA2 by light emitted from the second light emitting element EDb among the corresponding first and second light emitting element EDa and EDb included in each of a plurality of subpixels disposed in the second display area DA2.

When a multi-view display is implemented as one of cases 1 to 3 Cases 1 to 3 of FIG. 11, the first view image VIEW1 and the second view image VIEW2 may be images visible when the display panel 110 is viewed in different directions. The first view image VIEW1 and the second view image VIEW2 may be different images.

When a multi-view display is implemented as one of cases 4 and 5 Cases 4 and 5 of FIG. 12, a first view image VIEW1 may be formed in the display area DA by light emitted from the first light emitting element EDa among the corresponding first and second light emitting element EDa and EDb included in each of a plurality of subpixels SP disposed in the display area DA, and a second view image VIEW2 may be formed in the display area DA by light emitted from the second light emitting element EDb among the corresponding first and second light emitting element EDa and EDb included in each of the plurality of subpixels disposed in the display area DA.

When a user views the display panel 110 from the front thereof instead of viewing from one or more sides as in FIGS. 11 and 12, the user may not view a displayed image (or video). When the user views the display panel 110 from the front, the first view image VIEW1 and the second view image VIEW2 may not be visible, and a black image may be visible.

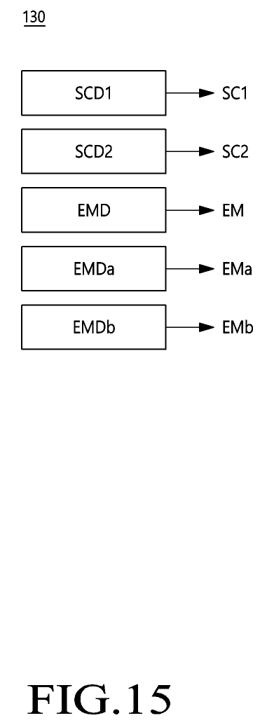

FIG. 15 illustrates an example configuration of the gate-in-panel circuit GIPC of the display device 100 according to aspects of the present disclosure. In discussions that follow, reference is also made to the configurations of FIG. 13.

The subpixel SP of FIG. 13 can be driven by receiving first and second scan signals (SC1 and SC2), a main emission control signal EM, and first and second emission control signals (EMa and EMb). The first and second scan signals (SC1 and SC2), the main emission control signal EM, and the first and second emission control signals (EMa and EMb) may be types of gate signal.

Accordingly, the gate driving circuit 130 may include a first scan driving circuit SCD1 configured to output the first scan signal SC1, a second scan driving circuit SCD2 configured to output the second scan signal SC2, a main light emission control driving circuit EMD configured to output the main light emission control signal EM, a first light emission control driving circuit EMDa configured to output the first light emission control signal EMa, and a second light emission control driving circuit EMDb configured to output the second light emission control signal EMb.

Each of the first scan driving circuit SCD1, the second scan driving circuit SCD2, the main light emission control driving circuit EMD, the first light emission control driving circuit EMDa, and the second light emission control driving circuit EMDb may have a structure equal or similar to the structure of the gate driving block GBLK illustrated in FIG. 2.

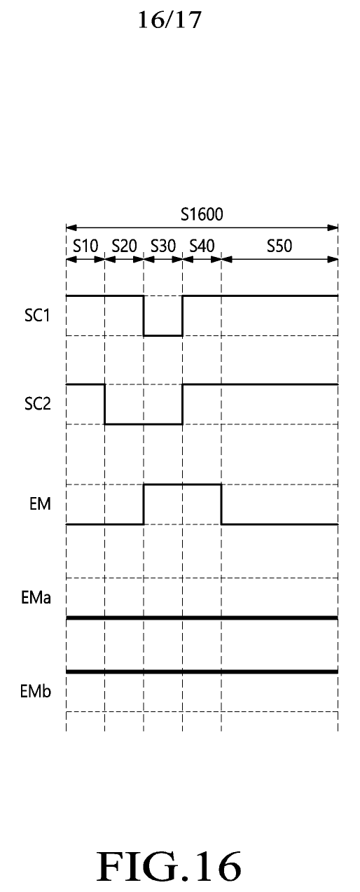

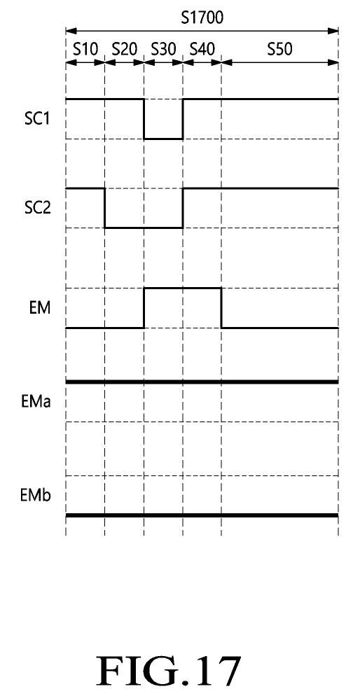

FIGS. 16 and 17 are example driving timing diagrams for causing a first light emitting element EDa and a second light emitting element EDb in a subpixel to emit light in the display device 100 according to aspects of the present disclosure. In discussions that follow, reference is also made to the configurations of FIG. 13.

Referring to FIGS. 16 and 17, in one or more example implementations, a multi-view display driving period of the display device 100 may include a first emission driving period S1600 for causing the first light emitting element EDa to emit light and a second emission driving period S1700 for causing the second light emitting element EDb to emit light.

Each of the first emission driving period S1600 and the second emission driving period S1700 may include first to fifth periods (S10 to S50). According to the example of FIG. 13, as all of the transistors (DT, T1 to T4, T5a, T6a, T5b, and T6b) may be p-types, turn-on and turn-off level voltages of each of the gate signals (SC1, SC2, EM, EMa, and EMb) applied to the gate nodes of the transistors (DT, T1 to T4, T5a, T6a, T5b, and T6b) may be a low level voltage and a high level voltage, respectively.

During the first emission driving period S1600, a first emission control signal EMa may have a turn-on level voltage, and a second emission control signal EMb may have a turn-off level voltage.

During the second emission driving period S1700, the first emission control signal EMa may have a turn-off level voltage, and the second emission control signal EMb may have a turn-on level voltage.

In each of the first emission driving period S1600 and the second emission driving period S1700, during a first period S10, a first scan signal SC1 may have a turn-off level voltage, a second scan signal SC2 may have a turn-off level voltage, and a main emission control signal EM may have a turn-on level voltage. During the first period S10, the third, fourth, and sixth transistors (T3, T4, and T6a) may be turned on. During the first period S10, a reference voltage Vref may be applied to the first node N1 through the third transistor T3.

In each of the first emission driving period S1600 and the second emission driving period S1700, during a second period S20, the first scan signal SC1 may have the turn-off level voltage, the second scan signal SC2 may have a turn-on level voltage, and the main emission control signal EM may have the turn-on level voltage. During the second period S20, the third, fourth, and sixth transistors (T3, T4, and T6a) may maintain the turn-on state, and the second, fifth, and seventh transistors (T2, T5a, and T5b) may be turned on.

During the second period S20, the reference voltage Vref may be applied to the first electrode (or the anode electrode or pixel electrode) of the first light emitting element EDa through the fifth transistor T5a.

The reference voltage Vref applied to the first electrode of the first light emitting element EDa may be applied to the fifth node N5 through the sixth transistor T6a. The reference voltage Vref applied to the fifth node N5 may be applied to the fourth node N4 through the fourth transistor T4. The reference voltage Vref applied to the fourth node N4 may be applied to the second node N2 through the second transistor T2.

In each of the first emission driving period S1600 and the second emission driving period S1700, during a third period S30, the first scan signal SC1 may have a turn-on level voltage, the second scan signal SC2 may have the turn-on level voltage, and the main emission control signal EM may have a turn-off level voltage. During the third period S30, the third and fourth transistors (T3 and T4) may be turned off, and the first transistor T1 may be turned on.

During the third period S30, a data signal Vdata may be supplied to the first node N1 through the first transistor T1. The data signal Vdata may be a data signal for enabling the first light emitting element EDa to emit light.

During each of the first emission driving period S1600 and the second emission driving period S1700, during a fourth period S40, the first scan signal SC1 may have the turn-off level voltage, the second scan signal SC2 may have the turn-off level voltage, and the main emission control signal EM may have the turn-off level voltage.

During the fourth period S40, the first, second, fifth, and seventh transistors (T1, T2, T5a, and T5b) may be turned off, and the sixth transistor T6a may be turned on.

During each of the first emission driving period S1600 and the second emission driving period S1700, during a fifth period S50, the first scan signal SC1 may have the turn-off level voltage, the second scan signal SC2 may have the turn-off level voltage, and the main emission control signal EM may have the turn-on level voltage.

During the fifth period S50 of the first emission driving period S1600, the fourth transistor T4 may be turned on by the main emission control signal EM, and the sixth transistor T6a may maintain the turn-on state by the first emission control signal EMa. At this time, a driving current may be supplied to the first light emitting element EDa through the fourth transistor T4 and the sixth transistor T6a, and thereby, the first light emitting element EDa can emit light.

During the fifth period S50 of the second emission driving period S1700, the fourth transistor T4 may be turned on by the main emission control signal EM, and the eighth transistor T6b may maintain the turn-on state by the second emission control signal EMb. At this time, a driving current may be supplied to the second light emitting element EDb through the fourth transistor T4 and the eighth transistor T6b, and thereby, the second light emitting element EDb can emit light.

The examples, aspects, and implementations of the present disclosure described above have been described for illustrative purposes, and those skilled in the art will appreciate that various modifications, additions and substitutions are possible, without departing from the scope and spirit of the disclosure as disclosed in the accompanying claims. Therefore, the technical features of the present disclosure described in the above description or shown in the accompanying drawings should be interpreted as illustrative only and should not be taken as limiting the scope of the present disclosure.

What is claimed is:

1. A display device comprising:
a display panel comprising 2n subpixel lines arranged as a first subpixel line to an nth subpixel line, an (n+1)th subpixel line to a (2n-1)th subpixel line, and a 2nth subpixel line disposed in a display area, n being a natural number greater than or equal to 2; and
a gate driving circuit configured to supply a gate signal to each of the 2n subpixel lines,
wherein the 2n subpixel lines are grouped into n driving groups arranged as a first driving group to an nth driving group, each driving group having two subpixel lines, and
wherein for each driving group of the n driving groups, identical gate signals are supplied to the two subpixel lines in the driving group.

2. The display device of claim 1, wherein during at least one frame period, the n driving groups are sequentially driven starting from a first driving group to an nth driving group, and the two subpixel lines included in the each driving group of the n driving groups are simultaneously driven.

3. The display device of claim 1, wherein among the two subpixel lines included in the each driving group of the n driving groups, one subpixel line is disposed in a first display area of the display area, and another subpixel line is disposed in a second display area different from the first display area in the display area.

4. The display device of claim 3, wherein among the 2n subpixel lines, the first subpixel line to the nth subpixel line are disposed in the first display area, and the (n+1)th subpixel line to the 2nth subpixel line are disposed in the second display area,
wherein among the n driving groups, the first driving group comprises the first subpixel line among the first subpixel line to the nth subpixel line and the (n+1)th subpixel line among the (n+1)th subpixel line to the 2nth subpixel line, and wherein a first gate signal supplied to the first subpixel line and an (n+1)th gate signal supplied to the (n+1)th subpixel line are identical to each other, and
wherein among the n driving groups, the nth driving group comprises the nth subpixel line among the first subpixel line to the nth subpixel line and the 2nth subpixel line among the (n+1)th subpixel line to the 2nth subpixel line, and wherein an nth gate signal supplied to the nth subpixel line and a 2nth gate signal supplied to the 2nth subpixel line are identical to each other.

5. The display device of claim 3, wherein when a first image starts to be displayed in the first display area, a second image different from the first image starts to be displayed in the second display area.

6. The display device of claim 1, wherein the display area comprises a first display area and a second display area, and
wherein the two subpixel lines included in the each driving group of the n driving groups are disposed in either the first display area or the second display area.

7. The display device of claim 6, wherein among the 2n subpixel lines, the first subpixel line to the nth subpixel line are disposed in the first display area, and the (n+1)th subpixel line to the 2nth subpixel line are disposed in the second display area,
wherein among the n driving groups, the first driving group comprises the first subpixel line and the second subpixel line among the first subpixel line to the nth subpixel line, and wherein a first gate signal supplied to the first subpixel line and a second gate signal supplied to the second subpixel line are identical to each other, and
wherein among the n driving groups, the nth driving group comprises the (2n-1)th subpixel line and the 2nth subpixel line among the (n+1)th subpixel line to the 2nth subpixel line, and wherein a (2n-1)th gate signal supplied to the (2n-1)th subpixel line and a 2nth gate signal supplied to the 2nth subpixel line are identical to each other.

8. The display device of claim 6, wherein after a first image is displayed in the first display area, a second image different from the first image is displayed in the second display area.

9. The display device of claim 1, further comprising a detection circuit configured to receive a detection reference voltage and at least one control signal, and output a detection signal determined according to the at least one control signal,
wherein the at least one control signal is one of two gate signals applied to the two subpixel lines included in the nth driving group which is driven last among the n driving groups.

10. The display device of claim 9, wherein the detection circuit is configured to receive the detection reference voltage, a first control signal, and a second control signal, and output the detection signal determined according to the first control signal and the second control signal,
wherein the first control signal and the second control signal are the two gate signals applied to the two subpixel lines included in the nth driving group driven last among the n driving groups, and
wherein when the first control signal and the second control signal are turn-on level voltages, the detection signal has a voltage corresponding to the detection reference voltage, and when at least one of the first control signal or the second control signal is a turn-off level voltage, the detection signal has a voltage different from the detection reference voltage.

11. The display device of claim 10, wherein the nth driving group driven last among the n driving groups comprises the (2n-1)th subpixel line and the 2nth subpixel line,
wherein the first control signal is a (2n-1)th gate signal applied to the (2n-1)th subpixel line, and the second control signal is a 2nth gate signal applied to the 2nth subpixel line,
wherein the detection circuit comprises (i) a first detection transistor configured to receive the detection reference voltage and is turned on or turned off according to the first control signal, and (ii) a second detection transistor configured to be turned on or turned off according to the second control signal, and
wherein the first detection transistor and the second detection transistor are connected in series, and when both the first detection transistor and the second detection transistor are turned on, the detection signal having the detection reference voltage is output from the second detection transistor.

12. The display device of claim 9, wherein the detection circuit is configured to receive the detection reference voltage and a first control signal, and outputs the detection signal determined according to the first control signal,
wherein the first control signal is one of the two gate signals applied to the two subpixel lines included in the nth driving group driven last among the n driving groups, and
wherein when the first control signal is a turn-on level voltage, the detection signal has a voltage corresponding to the detection reference voltage, and when the first control signal is a turn-off level voltage, the detection signal has a voltage different from the detection reference voltage.

13. The display device of claim 12, wherein the first control signal is one of a (2n-1)th gate signal and a 2nth gate signal applied to the (2n-1)th subpixel line and the 2nth subpixel line included in the nth driving group driven last among the n driving groups,
wherein the detection circuit comprises a first detection transistor configured to receive the detection reference voltage and is turned on or turned off according to the first control signal, and
wherein when the first detection transistor is in a turn-on state, the detection signal having the detection reference voltage is output from the first detection transistor.

14. The display device of claim 9, further comprising a group driving error response device configured to control a black screen to be displayed, a power-off process to be performed, or a rebooting process to be performed based on the detection signal.

15. The display device of claim 1, wherein each subpixel of a plurality of subpixels included in the 2n subpixel lines comprises:
a first light emitting element;
a second light emitting element; and
a subpixel circuit configured to (i) drive one of the first light emitting element or the second light emitting element or (ii) alternately drive the first light emitting element and the second light emitting element.

16. The display device of claim 15, wherein the display area comprises a first display area and a second display area,
wherein the plurality of subpixels comprise a plurality of first subpixels disposed in the first display area and a plurality of second subpixels disposed in the second display area,
wherein a first view image is formed in the first display area by emission of the first light emitting element among the first light emitting element and the second light emitting element included in each of the plurality of first subpixels,
wherein a second view image is formed in the second display area by emission of the second light emitting element among the first light emitting element and the second light emitting element included in each of the plurality of second subpixels, and
wherein the first view image and the second view image are images visible when the display panel is viewed from different directions.

17. The display device of claim 15, wherein a first view image is formed in the display area by emission of the first light emitting element among the first light emitting element and the second light emitting element included in each of the plurality of subpixels, and
wherein a second view image is formed in the display area by emission of the second light emitting element among the first light emitting element and the second light emitting element included in each of the plurality of subpixels.

18. A display device comprising:
a display panel comprising a plurality of subpixels disposed in a display area,
wherein each subpixel of the plurality of subpixels comprises:
a first light emitting element;
a second light emitting element; and
a subpixel circuit configured to (i) drive one of the first light emitting element or the second light emitting element or (ii) alternately drive the first light emitting element and the second light emitting element,
wherein the subpixel circuit comprises:
a common circuit comprising a common transistor configured to be turned on during a driving period of the first light emitting element and a driving period of the second light emitting element;
a first individual circuit comprising a first individual transistor configured to be turned on during the driving period of the first light emitting element; and
a second individual circuit comprising a second individual transistor configured to be turned on during the driving period of the second light emitting element.

19. The display device of claim 18, wherein the subpixel circuit comprises 5 nodes including a first node, a second node, a third node, a fourth node, and a fifth node,
wherein the common circuit includes:
a driving transistor connected between the third node and the fourth node;
a first transistor connected between a data line and the first node;
a second transistor connected between the second node and the fourth node;
a third transistor connected between a reference voltage line and the first node; and
a fourth transistor connected between the fourth node and the fifth node, and
wherein the first individual circuit comprises a fifth transistor connected between the reference voltage line and a first electrode of the first light emitting element, and a sixth transistor connected between the fifth node and a first electrode of the first light emitting element, and the second individual circuit comprises a seventh transistor connected between the reference voltage line and a first electrode of the second light emitting element, and an eighth transistor connected between the fifth node and a first electrode of the second light emitting element.

20. The display device of claim 18, wherein the display area comprises a first display area and a second display area,
wherein the plurality of subpixels comprise a plurality of first subpixels disposed in the first display area and a plurality of second subpixels disposed in the second display area, and
wherein a first view image is formed in the first display area by emission of the first light emitting element among the first light emitting element and the second light emitting element included in each of the plurality of first subpixels, and a second view image different from the first view image is formed in the second display area by emission of the second light emitting element among the first light emitting element and the second light emitting element included in each of the plurality of second subpixels.
